(19) United States
(12) Patent Application Publication
(10) Pub. No.: US 2012/0118831 A1
(43) Pub. Date: May 17, 2012

(54) PROCESS FOR ENHANCED REMEDIATION OF CONTAMINATED WASTEWATERS, SOILS AND WASTEFORMS

(76) Inventors: Raymond T. Hemmings, Kennesaw, GA (US); Bruce J. Cornelius, Waterdown (CA)

(21) Appl. No.: 13/354,926

(22) Filed: Jan. 20, 2012

Related U.S. Application Data
(62) Division of application No. 12/802,681, filed on Jun. 11, 2010.
(60) Provisional application No. 61/268,320, filed on Jun. 11, 2009.

(51) Int. Cl. C02F 1/62; C02F 1/52; C02F 1/68; C01B 13/00; C02F 1/64

(52) U.S. Cl. 210/717; 423/592.1; 210/721; 210/722

(57) ABSTRACT

The present invention provides reagents that may be useful for treating wastes such as impure aqueous materials including wastewater to remove a significant proportion of the heavy metals that may be contained therein. The reagents include a calcium aluminosilicate (CAS) source and may include one or more of the following elements as an oxide: calcium oxide, aluminum oxide, silicon oxide, iron oxide, magnesium oxide, sodium oxide, potassium oxide, and sulfate. Further, the reagent comprises lime either as CaO or Ca(OH)₂. In addition, the invention provides methods for treating wastes such as impure aqueous materials to remove a significant proportion of the heavy metals contained therein.

### CROSS-REFERENCE TO RELATED APPLICATIONS

The present application is a divisional application of U.S. application Ser. No. 12/802,681, flied on Jun. 11, 2010, which claims the benefit under 35 U.S.C. §119(e) of U.S. Provisional Application No. 61/268,320, filed Jun. 11, 2009, the disclosure of which is hereby incorporated by reference.

### FIELD OF THE INVENTION

The present invention relates generally to processes and reagents for remedial treatment of contaminated waste waters, soils, or industrial solid wastes/sludges, and more specifically to sulfo-silico-pozzolanic reagents that can be optimized for fixation of specific contaminants in wastestreams, and to the method for producing the optimized reagents.

### BACKGROUND

The conventional remediation treatment of generally acidic contaminated waters, soils, sludges or other aqueous or semi-aqueous wasteforms depends primarily on the neutralization effect of calcined limestone, either as calcium oxide, also known as pure lime or quicklime (CaO), or the hydroxide form, also known as hydrated lime, Ca(OH)₂.

The chemical action of the calcined limestone is to first raise the alkalinity (pH) of the target wasteform to remove the hazard associated with acidity:

CaO+H₂O→Ca(OH)₂[hydration of lime]

Ca(OH)₂→Ca²⁺+2OH⁻[dissociation of hydrated lime]

OH⁻+H⁺→H₂O[neutralization of acidity]

This neutralization step is usually followed, or accompanied, by precipitation of insoluble metal hydroxides at elevated pH as a means of removing target metal (M) contaminants from solution:

Mⁿ⁺+nOH⁻→M(OH)ₙ[precipitation]

In general, the cleansed waste water can be removed shortly after treatment, at such a time as the solid metal hydroxides have precipitated, and then discharged, provided it meets local environmental standards. The precipitated solids from the treatment will largely consist of metal hydroxide, M(OH)ₙ, type compounds which need to be collected, dewatered and often retained for further treatment prior to disposal in a regulated landfill.

Significant problems and disadvantages can arise with the use of lime-based remediation. The net volume of the precipitated solid is contingent on the chemical nature of the hydroxide form, but more often than not it is a floc or gel like material of characteristically high surface area and low density. Practical difficulties arise with such a low density floc or gel, including the considerable time it can take to precipitate out, and the need for secondary dewatering and processing of the high volume, high water content solids. Both add time and costs to the treatment process.

The reagents and technology of the present invention can be used as viable alternatives for the remedial treatment of contaminated waste waters, soils, or industrial solid wastes in much the same manner as the lime-based systems mentioned above. However, the present invention provides a number of significant advantages compared with lime-based reagents. More specifically, these advantages include, but are not limited to (i) a high efficiency rate for removal of dissolved metal contamination from wastewater solutions, often equal to or better than pure lime systems; (ii) production of complex calcium sulfoaluminate/ferrite stabilized wasteforms by sulfo-silco-pozzolanic reaction chemistry, where the target contaminant metals are fixated though substitution in the stable crystal structure, which is generally more resistant to acidic conditions than plain lime-generated hydroxide forms; (iii) production of a denser, lower volume solid wasteform with high chemical and physical stability to environmental stressing (e.g., by the TCLP method) which simplifies water treatment sludge disposal by allowing management of reduced volumes of benign material in a conventional landfill; (iv) lower costs compared to pure lime/hydrated lime products, with the potential to utilize selected locally sourced materials in its manufacture; (v) easier packaging and distribution than lime/hydrated lime products due to the dry, free flowing nature of the mixtures; (vi) long-term reaction of reagent with residual alkalinity in solution, vastly decreasing the risk of producing a discharge of elevated pH; and (vii) improved sustainability by (a) significantly reduced greenhouse gas emissions during production of reagent by replacement of lime (the production of one ton of lime releases one ton of carbon dioxide during calcination), and (b) potential reduction of transportation charges with the use of local materials, where viable.

Lime-fly ash mixtures have been extensively used in geotechnical applications such as soil stabilization, highway construction, dredge management; and environmental remediation projects (solidification/stabilization). One exemplary lime-fly ash mixture commercially available is an approximately 50% mixture previously marketed by Klean Earth Environmental Company of Lynnwood, Wash. along with its silica micro encapsulation (SME) technology. These geotechnical applications are essentially based on pozzolan stabilization which generates physical strength through formation of cementitious reaction products which serve to bind the matrix together. There is not an established record of their use in wastewater treatment.

U.S. Pat. No. 5,277,826 teaches a process for wastewater treatment producing a usable end-product by mixing WWTS with lime and fly ash, to cause a temperature increase to above 70° C. for at least 30 minutes and to cause the pH to exceed 12 for at least 2 hours. The end-product may be compacted to produce a semi-impermeable, durable mass or the soil-like product may be used as landfill cover material. U.S. Pat. No. 5,220,111 teaches that fly ash generated from incineration of municipal solid waste (MSW) when placed in landfills under mild acid conditions can leach lead and cadmium. It further provides a process for stabilizing heavy metals in this fly ash involving calcining in the presence of an oxygen containing gas stream at a temperature greater than about 375° C. and substantially less than about 800° C. for times from about 170 seconds up to about 5 hours fly ash which has been subjected to lime scrubbing for acid gas removal. Such treated fly ash provides leachates containing heavy metal concentrations less than the EPA regulatory limit.

U.S. Pat. No. 5,430,235 provides a toxic waste fixant for detoxification of a contaminated material includes a mixture of ferric sulfate, manganese sulfate, organophilic clays, an oxidizer and aluminium sulfate. The respective amounts are preferably about 15-19 wt. % of ferric sulfate, about 15-19 wt. % of manganese sulfate, about 37-46 wt. % of organophilic clay, about 16-19 wt. % of an oxidizer and about 0-12.5 wt. %. of aluminium sulfate. All or part of the ingredients in said fixant may be added as a pretreatment into contaminated materials such as soils, sediments, or sludges. This pretreatment can range from 0 to 100 wt. % to the material. The fixant is blended with various amounts of Portland cement, and/or blast furnace slag, or lime, or gypsum, or coal fly ash, or cement kiln dust as a means to derive a chemical fixation treatment for contaminated soils, sediments, and sludges to prevent the leaching of organic and inorganic compounds and elements.

U.S. Reexamined Patent RE 29,783 teaches waste sludges containing small amounts of certain types of reactive materials that are treated by adding to such sludges materials capable of producing aluminum ions, lime and/or sulfate bearing compounds to produce a composition having a sufficient concentration of sulfate ions, aluminum ions and equivalents and calcium ions and equivalents. It further teaches that fly ash is the preferred source of aluminum ions for this purpose and that over a period of time such compositions harden by the formation of calcium sulfo-aluminate hydrates. Hardening of the sludge facilitates its disposition and may permit the reclamation of land occupied by large settling ponds for such sludge.

### SUMMARY OF THE INVENTION

In a first aspect, the present invention provides reagents that may be useful for treating wastes such as impure aqueous materials including wastewater in order to remove a signifiant proportion of the heavy metals that may be contained in the waste. The reagents typically include a calcium aluminosilicate (CAS) source and may include one or more of the following elements as an oxide: calcium oxide, aluminum oxide, silicon oxide, iron oxide, magnesium oxide, sodium oxide, potassium oxide, and sulfate. Each element may be present in an amount of about 0-70 weight %, represented as the element oxide. In some embodiments, calcium, represented as calcium oxide, is present in about 20 to 50 wt. % or 30 to 40 wt. %, aluminum, represented as aluminum oxide, is present in about 5 to 35 wt. % or 10 to 30 wt. %, silicon, represented as silicon oxide, is present in about 20 to 70 wt. % or 30 to 60 wt. %, iron, represented as iron oxide, is present in about 0 to 15 wt. % or 4 to 10 wt. %, magnesium, represented as magnesium oxide, is present in about 0 to 12 wt. % or 1 to 10 wt. %, sodium, represented as sodium oxide, is present in about 0 to 10 wt. % or 0 to 2 wt. %, potassium, represented as potassium oxide, is present in about 0 to 5 wt. % or 0.3 to 2.5 wt. %, sulfate is present in about 0 to 10 wt. % or 0.3 to 3 wt. %. The reagent may feature a loss on ignition (LOI) in the range of about 0.01 to 10% or about 0.1 to 2.5%. The reagents further include lime, hydrated or non-hydrated, for instance as CaO or Ca(OH)₂ or lime kiln dust, a by-product of lime manufacture and containing CaO. The lime may be present in the reagent in an amount of about 1-60 wt. %, or about 5-55 wt. %, or about 10-50 wt. %. In some particular embodiments, the lime is present in an amount of about 10-25 wt. % or 10-15 wt. %. Likewise, the calcium aluminosilicate source may be present in an amount of about 30-99 wt. %, or about 45-95 wt. %, or about 50-90 wt. %. In some particular embodiments, the calcium aluminosilicate source is present in an amount of about 75-90 wt. % or 85-95 wt. %. In some embodiments, calcium is present in the reagent in a total amount of at least 25 wt. %, 30 wt. %, 35 wt. %, 40 wt. %, 45 wt. %, 50 wt. %, 60 wt. % or more, expressed as the oxide, CaO. In some instances, lime may be added to a calcium aluminosilicate source (CAS) according to the following general formula

% required added lime=40−(% CaO contained in the CAS)

to provide a final reagent. CaO is generally the calcium content expressed as the element oxide CaO.

The calcium aluminosilicate source may be coal combustion by-products such as, for instance, fly ash and bottom ash from pulverized coal combustion, spray drier ash, fluidized bed combustion ash, metal smelting by-products such as iron production slags, non-ferrous slags, or other high temperature vitreous materials such as post-industrial or post-consumer glasses. The reagents may further include one or more additives from among sulfates, for example, calcium sulfate (gypsum), the by-product gypsum from flue gas desulfurization or neutralization of acidic water (chemical gypsum); sulfide, for example, ground granulated slag from an iron ore blast furnace; iron compounds; aluminum compounds (e.g. sulfate, alums); and carbon (activated or partially activated), particularly from coal ash sources. The one or more additives may be present in an amount of about 0.1 wt. %, 0.25 wt. %, 0.50 wt. %, 1, 2, 3, 4, or 5 wt. % or from about 0-25 wt. %, about 1-15 wt. %, or about 2-10 wt. %.

The reagents may be used in the treatment of impure materials, including aqueous materials such as wastewater. The reagents are denser than water, such as for instance, 150%, 200%, 250% or 2, 2.5, 3, 5, or more times the density of water, and the wasteform settles. The reagents interact with heavy metal ions to form relatively tightly bound wasteform for disposal. The reagents may be effective in removing 10, 20, 30, 40, 50, 60, 70, 75, 80, 90, 95, 97, 99, 99.5, or more percent, almost all or substantially all of the heavy metal ions present in an impure aqueous material such as wastewater. In some embodiments, the reagents are powders where the majority or substantially all the particles are finer than about 500, 300, 250, 200, 175, or 150 μm.

In a second aspect, the invention provides methods for removing contaminants from impure aqueous materials including wastewater by providing a reagent as described herein. In some instances, the contaminant is one or more heavy metal such as, for instance, chromium, cadmium, cobalt, copper, iron, mercury, lead, nickel, antimony, arsenic, barium, gold, manganese, molybdenum, selenium, silver, tin, tungsten, vanadium, and zinc. The reagents typically include a calcium aluminosilicate source and may include one or more of the following elements as an oxide: calcium oxide, aluminum oxide, silicon oxide, iron oxide, magnesium oxide, sodium oxide, potassium oxide, and sulfate. Each element may be present as an oxide in an amount of about 0-70 wt. %. In some embodiments, calcium oxide is present in about 20 to 50 wt. % or 30 to 40 wt. %, aluminum oxide is present in about 5 to 35 wt. % or 10 to 30 wt. %, silicon oxide is present in about 20 to 70 wt. % or 30 to 60 wt. %, iron oxide is present in about 0 to 15 wt. % or 4 to 10 wt. %, magnesium oxide is present in about 0 to 12 wt. % or 1 to 10 wt. %, sodium oxide is present in about 0 to 5 wt. % or 0 to 2 wt. %, potassium oxide is present in about 0 to 5 wt. % or 0.3 to 2.5 wt. %, sulfate is present in about 0 to 10 wt. % or 0.3 to 3 wt. %. The reagent may feature a loss on ignition (LOI) in the range of about 0.01 to 10% or about 0.1 to 2.5%. The reagents further include lime, hydrated or non-hydrated, for instance as CaO or Ca(OH)₂. The lime may be present in an amount of about 1-60 wt. %, or about 5-55 wt. %, or about 10-50 wt. %. In some particular embodiments, the lime is present in an amount of about 10-25 wt. % or 10-15 wt. %. Likewise, the calcium aluminosilicate source may be present in an amount of about 30-99 wt. %, or about 45-95 wt. %, or about 50-90 wt. %. In some particular embodiments, the calcium aluminosilicate source is present in an amount of about 75-90 wt. % or 85-95 wt. %.

The calcium aluminosilicate source may be coal combustion by-products such as, for instance, fly ash, bottom ash, spray drier ash, fluidized bed combustion ash, metal smelting by-products such as iron production slags, non-ferrous slags, or other high temperature vitreous materials such as post-industrial or post-consumer glasses. The reagents may further include one or more additives from among sulfates, for example, calcium sulfate (gypsum), the by-product gypsum from flue gas desulfurization or neutralization of acidic water (chemical gypsum); sulfide, for example, ground granulated slag from an iron ore blast furnace; iron compounds; aluminum compounds (e.g. sulfate, alums); and carbon (activated or partially activated), particularly from coal ash sources. The one or more additives may be present in an amount of about 0.1 wt. %, 0.25 wt. %, 0.50 wt. %, 1, 2, 3, 4, or 5 wt. % or from about 0-25 wt. %, about 1-15 wt. %, or about 2-10 wt. %.

The reagents are denser than water, such as for instance, 150%, 200%, 250% or 2, 2.5, 3, 5 or more times the density of water, and sludge settles. The reagents interact with heavy metal ions to form relatively tightly bound sludge for disposal. The method may be effective in removing 10, 20, 30, 40, 50, 60, 70, 75, 80, 90, 95, 97, 99, 99.5, or more percent, almost all or substantially all of the heavy metal ions present in an impure aqueous material such as wastewater. In some instances, the method using the reagents of the present invention is effective in removing 10%, 20%, 25%, 33%, 50%, or 75% more or even two or three times more contaminants than methods that use lime alone without the calcium aluminosilicate source described herein. In some embodiments, the reagents are powders where the majority or substantially all the particles are finer than about 500, 300, 250, 200, 175, or 150 μm.

In some embodiments, the contaminants such as heavy metal ions may be present in the impure material in amounts of about 0.1, 0.5, 1, 5, 10, 20, 25, 50, 75, 100, 200, 500, 1,000, or even 10,000 or more parts per million (ppm).

In some instances, the impure material such as an impure aqueous material including wastewater may have a pH below about 2, or in the range of pH 2-6. In some instances, at least about 0.5, at least about 1.0, at least about 1.2, at least about 1.5, at least about 1.8, at least about 2.0, at least about 2.5, or at least about 3.0 grams of reagent are added per liter of impure aqueous material. The amount required per liter is of course related to the acidity (pH) and the amount of contaminant present in an impure aqueous material. In other instances, about 10 to 10,000, or 1,000 to 5,000 parts of reagent are provided for each 100 parts of contaminant, and the amount may depend upon the pH of the contaminated material. The methods may be practiced in some instances at substantially atmospheric pressure or at an elevated pressure, and at substantially ambient temperature, at room temperature or at an elevated temperature of, for instance 35° C., 50° C., 60° C., 75° C., 100° C. or more.

In a third aspect, the invention provides a method for removing contaminants from impure materials including impure aqueous materials such as wastewater by (a) hydrolyzing lime components in a reagent described above; (b) neutralizing acidity in a solution containing a reagent described herein, (c) hydrolyzing an aluminosilicate network in a reagent at elevated pH thereby producing silicates and aluminates in solution, (d) reacting the solubilized aluminates in the presence of lime and sulfate thereby producing calcium sulfoaluminates, related to ettringite, which often have iron substituting for aluminum in the structure, (e) forming complex alkali silicate and aluminosilicate polymeric species in solution (where, N=Na or K), and (f) reacting the complex alkali silicate and aluminosilicate polymeric species with lime in solution to produce calcium silicate hydrate (C—S—H). Additional reactions occur when the method is for treating contaminated metal wastewaters. These reactions may include (g) precipitating insoluble metal hydroxides, and (h) complexing the metals in insoluble calcium sulfoaluminates and calcium silicate hydrates formed by the sulfo-pozzolanic and silico-pozzolanic reactions described above.

In a fourth aspect, the invention provides a precipitate produced by the methods described herein. The precipitate may contain the reagent described herein and one or more heavy metals, such as, for instance, chromium, cobalt, copper, iron, mercury, lead, nickel, antimony, arsenic, barium, gold, manganese, molybdenum, selenium, silver, tin, tungsten, vanadium, and zinc. The precipitate produced by the methods described herein is denser, and features a lower volume solid wasteform compared to a precipitate produced when lime is used without the reagents described herein. The precipitate can be engineered using Stokes' law, allowing a combination of extended suspension of silicate-bearing particles for enhanced residence time and subsequent reactivity compared to in-solution lime phases, and a lower solid volume for the precipitated, fixated material.

The precipitate accumulated using the reagents and methods described herein containing the heavy metals will have a solids bulk density typically in the range of 0.5 to 5.0, 1.0 to 4.0 or 1.5-2.5 g/cm³, with a true particle density approximating that of the metal hydroxide (e.g. 2.5 to 5.0 or 3.3-4.2 g/cm³). The precipitate may feature the presence of sulfoaluminate as well as silicate bonding in the wasteforms, indicative of both complexation and encapsulation of fixated metals. The precipitate provides for a substantially more stable chemical environment for metal fixation than a simple formation of metal hydroxides by lime treatment. The metal fixated precipitates produced with the reagents have high stability to environmental stressing, for example, as would be encountered by exposure to low pH conditions. The precipitate may be characterized by a volume that is 10, 20, 25, 30, 33, 40 or 50% or more less than the volume of a precipitate produced when a similar amount of lime is used alone without a calcium aluminosilicate (CAS) source as is provided with the reagents of the present invention.

Other aspects and advantages of the present invention will be apparent from the following description, examples, and the appended claims.

### BRIEF DESCRIPTION OF THE FIGURES

FIG. 1 provides a process diagram exemplary of the methods of the present invention whereby the reagents of the invention are added to wastewater for treatment resulting in separation of a solid fixated wasteform from clear water. The solid fixated wasteform may then be disposed in a landfill and the clear water discharged.

FIG. 2 provides neutralization curves for various combinations of selected CAS sources and lime in acidic sulfate solutions, initial pH of about 2.5 (top). Sequential addition of lime to selected CAS mixtures to achieve a final pH of about 11.

FIG. 3 depicts a reaction rate of lime (top) compared to the present reagents (bottom) with surrogate metal ions at an initial concentration of 50 ppm. Note the extremely rapid precipitation from solution, and the superior performance of the reagents.

FIG. 4 depicts precipitation of surrogate metals from acid sulfate solution at 28 days, starting at 50 ppm for each surrogate metal. The lower graph (with amplified scale) shows the details of the solution metal concentrations below 1 ppm.

FIG. 5 provides environmental stressing (TCLP) results for precipitated products from the present reagents.

FIG. 6 depicts the precipitation volume of lime compared to the present reagents for the same initial metals solution, showing a 50% reduction in solids volume.

FIG. 7 demonstrates the precipitation of surrogate metals from sulfate solution at 7 days (top) and 28 days (bottom), starting at 50 ppm for each metal. The lower graph shows several high CAS content (low lime) mixes and formulations using customized particle sized ash sources.

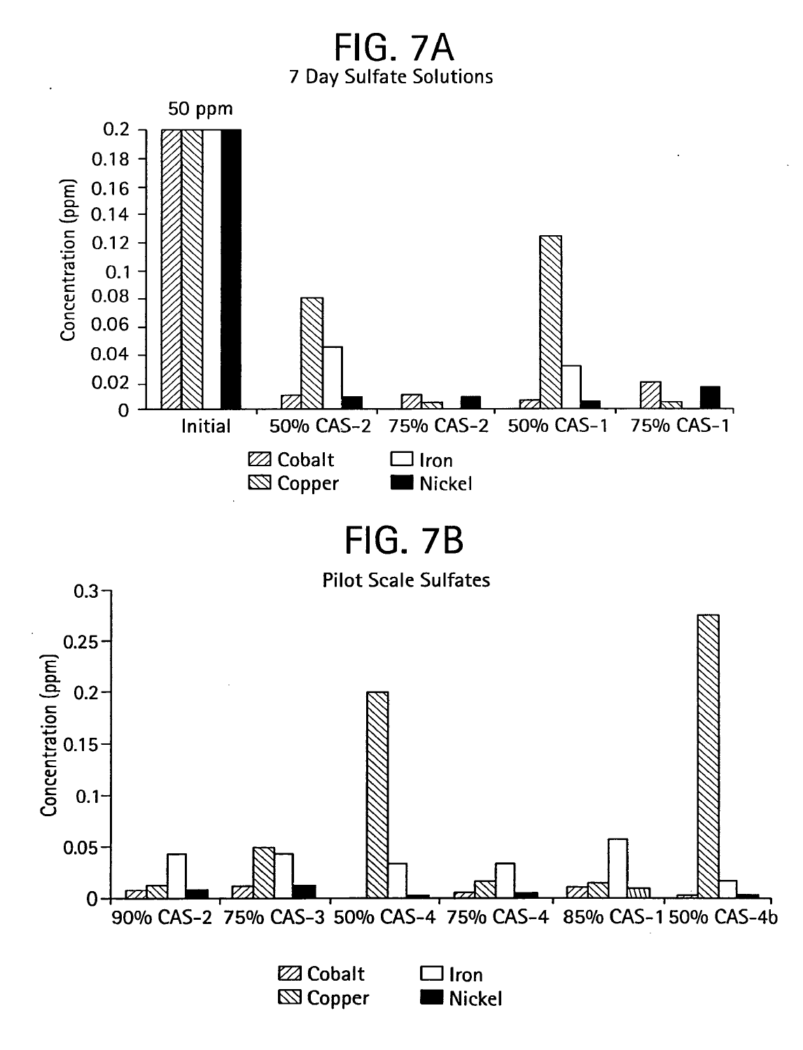

FIG. 8 demonstrates the precipitation of surrogate metals from acid chloride solution, starting at 50 ppm for each metal. Note the expanded scale on the lower graph at 0.1 ppm.

FIG. 9 provides environmental stressing results for reagent products in acidic chloride fluids at 28 days age. Note expanded scale on lower graph at 2 ppm.

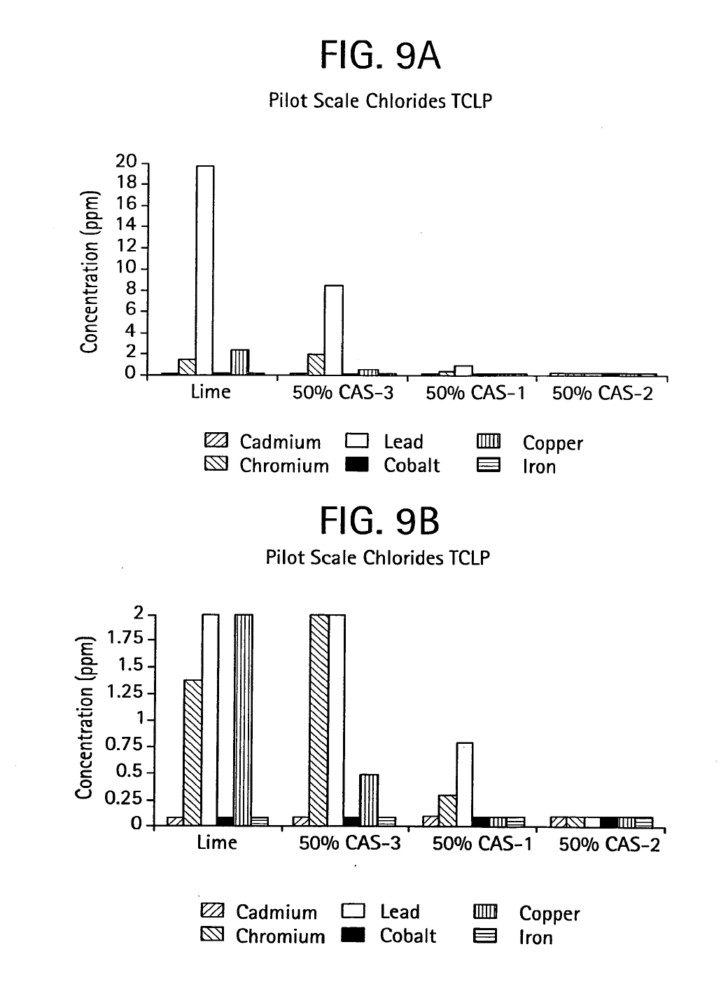

FIG. 10 is an X-ray powder diffraction pattern (CuK_{α}) showing capture of mercury in the form of mercury sulfide from an initial solution containing 25 ppm mercury nitrate.

FIG. 11 is an X-ray powder diffraction pattern (CuK_{α}) showing early capture of Pb by a CAS-1 formulation.

FIG. 12 is a typical series of X-ray powder diffraction patterns (CuK_{α}) showing growth of metal sulfate phases with the present reagent formulations in metal sulfate solutions from 30 minutes (top) to 7 days (bottom).

FIG. 13 is a typical X-ray powder diffraction pattern (CuK_{α}) showing growth of metal sulfate phases with the present reagent formulations in metal chloride solutions.

FIG. 14 is an SEM-EDXA for a solid phase produced using the present reagents.

FIG. 15 is an SEM-EDXA for a solid phase produced using the present reagents.

FIG. 16 is an SEM-EDXA for a solid phase produced using the present reagents.

### DETAILED DESCRIPTION OF THE INVENTION

As used herein the following definitions are provided, which are adopted from ASTM C-618: Standard Specification for Coal Fly Ash and Raw or Calcined Natural Pozzolan for Use as a Mineral Admixture in Concrete:

By “Pozzolan” is meant a siliceous or siliceous and aluminous material which in itself possesses little or no cementitious value but will, in finely divided form and in the presence of moisture, chemically react with calcium hydroxide at ordinary temperatures to form compounds possessing cementitious properties.

By “Class N Pozzolan” is meant a raw or calcined natural pozzolans that comply with the applicable requirements for the class as given herein, such as some diatomaceous earths; opaline cherts and shales; tuffs and volcanic ashes or pumicites, calcined or uncalcined; and various materials requiring calcination to induce satisfactory properties, such as some clays and shales.

By “Class F Fly Ash” is meant fly ash normally produced from burning anthracite or bituminous coal that meets the applicable requirements for this class as given herein. This class fly ash has pozzolanic properties.

By “Class C Fly Ash” is meant fly ash normally produced from lignite or subbituminous coal that meets the applicable requirements for this class as given herein. This class fly ash, in addition to having pozzolanic properties, also has some cementitious properties.

and ASTM C-989: Standard Specification for Ground Granulated Blast-Furnace Slag for Use in Concrete and Mortars:

By “Blast-Furnace Slag” is meant the nonmetallic product, consisting essentially of silicates and aluminosilicates of calcium and other bases that is developed in a molten condition simultaneously with iron in a blast furnace.

By “Granulated Blast-Furnace Slag” is meant the glassy granular material formed when molten blast-furnace slag is rapidly chilled as by immersion in water, with or without compositional adjustments made while the blast-furnace slag is molten.”

The reagents of this invention are preferably based on an intimate blend of calcium aluminosilicate (CAS) and/or alkali silicate glassy materials, together with a source of active lime, including but not limited to quicklime [CaO], hydrated lime [Ca(OH)₂], or by-product sources of a lime such as lime kiln dust, all in specific proportions. Typical bulk chemical compositions of six calcium aluminosilicates (CAS 1-6) selected for illustrative purposes are collected in Table 1.

TABLE 1

| Element as | | | | | | |
|---|---|---|---|---|---|---|
| Oxide | CAS-1 | CAS-2 | CAS-3 | CAS-4 | CAS-5 | CAS-6 |
| SiO₂ | 36.0 | 31.9 | 56.5 | 54.6 | 55.9 | 40.3 |
| Al₂O₃ | 18.6 | 18.5 | 22.3 | 20.9 | 27.4 | 8.4 |
| Fe₂O₃ | 6.6 | 5.1 | 4.4 | 5.8 | 7.7 | 0.6 |
| CaO | 25.2 | 29.5 | 10.6 | 12.6 | 1.2 | 38.6 |
| MgO | 5.9 | 5.6 | 1.7 | 1.8 | 0.9 | 11.2 |
| Na₂O | 1.9 | 1.4 | 0.3 | 0.3 | 0.3 | 0.4 |
| K₂O | 0.5 | 0.3 | 0.8 | 0.7 | 2.4 | 0.6 |
| SO₃ | 1.6 | 2.8 | 0.4 | 0.3 | 0.4 | 2.3 |
| LOI | 0.2 | 0.5 | 0.4 | 1.1 | 1.9 | 0.5 |

Typical proportions ranges for the constituents of the reagents produced from the different CAS sources are shown in Table 2. The reagents are typically powders where substantially all the particles are finer than about 150-200 μm. The glassy calcium aluminosilicates are provided by a variety of sources such as, but not limited to, coal combustion by-products (including fly ash, bottom ash, spray drier ash, fluidized bed combustion ash), iron production slags, non-ferrous slags, and post-industrial or post-consumer glasses.

TABLE 2

| Reagent | Lime | -- Calcium Aluminosilicate Source -- | | | | | |
|---|---|---|---|---|---|---|---|
| Identification | [CaO/Ca(OH)₂] | CAS-1 | CAS-2 | CAS-3 | CAS-4 | CAS-5 | CAS-6 |
| Lime | 100% | — | — | — | — | — | — |
| SWX-Series 1 | 10-50% | 50-90% | — | — | — | — | — |
| SWX-Series 2 | 10-50% | — | 50-90% | — | — | — | — |
| SWX-Series 3 | 10-50% | — | — | 50-90% | — | — | — |
| SWX-Series 4 | 10-50% | — | — | — | 50-90% | — | — |
| SWX-Series 5 | 10-50% | — | — | — | — | 50-90% | — |
| SWX-Series 6 | 10-50% | — | — | — | — | — | 50-90% |

The reagent is an environmentally sustainable product, whereas lime and hydrated lime products are both manufactured products which are not sustainable. Therefore, production of the reagent carries with it a considerably reduced carbon footprint compared with the manufacture of lime products. In this respect, it is relevant to note that the manufacture of 1 ton of lime releases about 1 ton of the greenhouse gas carbon dioxide (CO₂) to the atmosphere. This is in addition to any contribution from fossil fuels used to heat the calcining ovens or kilns. The corresponding CO₂ emissions from the manufacture of the reagents are 90%, or more, less than that of pure lime.

The reagents also incorporate a high content of post-industrial recycled “waste” material. This not only diverts the wastes from disposal and extension of landfill use, but it also much more cost-effective. With lime costs in excess of $100/ton the reagents can be substantially (up to 80%) less expensive.

Fly ash is a fine particulate produced as a by-product/waste during the combustion of coal. Chemically, it can be broadly described as a calcium aluminosilicate glass, together with accessory minerals including quartz, hematite, ferrite spinel, mullite, crystalline calcium aluminates and silicates, etc. ASTM uses Class F and Class C terminology, ostensibly based on the origin of the coal and its inherent calcium content. The ash for the reagents is preferably derived from bituminous, subbituminous and lignite coal sources; and more preferably derived from subbituminous and lignite coal. A particular advantage is that the ash source(s) used for the reagents do not need to conform to the specification limits defined in ASTM C-618, as factors such as fineness and high LOI (loss on ignition) can be tolerated, and in some cases be used to enhance the effectiveness of the reagent formulations. This allows the reagents to potentially utilize a significant quantity of currently unused fly ash. In addition, other forms of coal combustion ash, such as fluidized bed combustion (FBC) discharge, spray dryer ash (SDA), and various other pollution abatement residues can be utilized to good effect in specific formulations.

Fly ash is available from coal burning electric power plants throughout North America and throughout the world. In the United States and Canada, there is a regional distribution of Class C and Class F materials. Currently, about 70% of fly ash is not used and is sent for disposal at significant cost and with significant long term potential environmental impact, including failure of containment ponds, such as occurred at the Tennessee Valley Authority Kingston facility in December 2008.

Other reactive silicate and aluminosilicates derived from smelting processes, glass manufacture and related industries are acceptable as supplemental and/or primary components of the reagents. Particular CAS sources with desirable properties, such as available sulfide for targeted lead, cadmium and mercury removal, can be incorporated into specific reagent formulations.

Optimal properties of the present reagents are governed by an intimate knowledge of the calcium aluminosilicate, particularly its chemistry, mineralogy and physical properties, providing means for developing optimal ratios of CAS to lime for each CAS source and for each wastewater or contaminated solids stream. Other formulations based on alternative sources of CAS materials for remediation of contaminants, particularly those which are typically unsuitable for lime treatment, are included.

Optionally, the particle size distribution of the reagents can be adjusted to optimize reactivity (metal fixation) and settling times and hence allow controlled and complete reaction with contaminated waste streams. This can be achieved typically by processing the reagent with high efficiency grinding and air classification processes such as those described in U.S. Pat. No. 6,802,898, the disclosure of which is herein incorporated by reference, that can produce a final product with a very closely controlled particle size distribution; for example, one where the median particle size is reduced to the 1-10 μm range. This can be used, in conjunction with knowledge of the particle morphology and particle density, to control the settling rate of the reagent and optimize both the reaction rate and the time to produce a stable precipitate. A further enhancement to the physical processing option is to intergrind the CAS and lime components to achieve the most intimate contact of the particles and the greatest reactivity.

### Method of Use

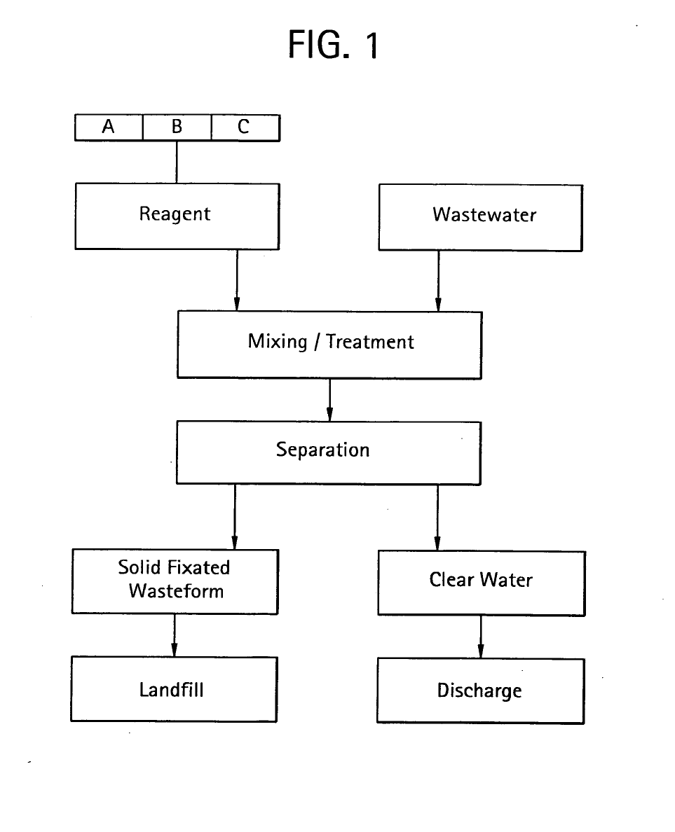

The reagents can be effectively substituted for lime or hydrated lime in a variety of conventional environmental treatment protocols, including but not limited to lime dosers for wastewater treatment, broadcasting/tilling for contaminated soils, deep soil mixing, slurry walls, etc. FIG. 1 provides a process diagram exemplary of the methods of the present invention whereby the reagents of the invention are added to Wastewater for treatment resulting in separation of a solid fixated wasteform from clear water. The solid fixated wasteform may then be disposed in a landfill and the clear water discharged.

The reagents provide rapid scavenging and fixation of dissolved metals in wastewater and subsequent sequestration/complexation in stable, insoluble calcium aluminosilicates and/or calcium sulfoaluminates. Typical actions of experimental formulations are outlined in the examples cited below.

The reactions occurring with the reagent may be simplified as follows. The reactants include, but are not limited to, calcium hydroxide [Ca(OH)₂] from the hydration of the lime component, gypsum (CaSO₄.2H₂O), anhydrite (CaSO₄), alkali sulfates (M₂SO₄, where M=Na, K), and aluminosilicates [—Si—O—Si—O—Al—O—]ₙ.

The first stage of the reaction involves hydrolysis of the lime components in the reagent:

CaO+H₂O→Ca(OH)₂→Ca²⁺+2OH⁻ {Eqn. 1}

and neutralization of acidity in solution:

OH⁻+H⁺→H₂O {Eqn. 2}

The next stage of the reaction involves hydrolysis of the aluminosilicate network in the CAS at elevated pH, producing silicates and aluminates in solution:

≡Si—O—Al≡+OH⁻→≡Si—OH+[AlOH₄]⁻ {Eqn. 3}

This is followed by rapid reaction of the solubilized aluminates in the presence of lime and sulfate, producing calcium sulfoaluminates, related to ettringite, which often have iron substituting for aluminum in the structure:

6Ca²⁺+2[Al(OH)⁴]⁻+4OH⁻+3SO₄²⁻+26H₂O→[Ca₃Al(OH)₆.12H₂O].(SO₄)₃.2H₂O {Eqn. 4}

A further stage involves the formation of complex alkali silicate and aluminosilicate polymeric species in solution (where, N=Na or K):

≡Si—O—Si≡+M⁺OH⁻→≡Si—OH+≡Si—O⁻M⁺ {Eqn 5}

≡Si—O—Al≡+M⁺OH⁻→Si—OH+[Al(OH)₄]⁻M⁺ {Eqn. 6}

which subsequently react with lime in solution to produce calcium silicate hydrate (C—S—H), similar to the principal binder component in Portland cement concrete:

[SiO(OH)ₙ]^{x}^{_{−}}+yCa(OH)₂→yC—S—H+yH₂O {Eqn. 7}

The formation of both sulfoaluminates and silicate products involves alkali hydrolysis of aluminosilicates from the CSA constituents. Though these are not traditional pozzolanic reactions between lime and silica, they do involve reactions of the pozzolans present. For this reason the terms “sulfo-pozzolanic” and “silico-pozzolanic” have been used to distinguish the two processes [refs]: the former, the formation of ettringite through leaching of aluminum from the pozzolans in the presence of sulfate {Eqn. 4}; and the latter, the formation of complex silicates by alkali hydrolysis of siloxane groups from the pozzolans {Eqn. 7}.

Additional reactions occur when the reagent is used for the treatment of contaminated metal wastewaters. These involve precipitation of insoluble metal hydroxides, and the complexation of the metals in insoluble calcium sulfoaluminates and calcium silicate hydrates formed by the sulfo-pozzolanic and silico-pozzolanic reactions described above.

### Enhancements

These reactions may be enhanced by inclusion of other reactants to augment the basic components of the reagents provided by the lime and CAS constituents. These include, but are not limited to: sulfates, for example, calcium sulfate (gypsum), especially by-product gypsum from flue gas desulfurization or neutralization of acidic water (chemical gypsum); sulfide, for example, ground granulated slag from an iron ore blastfurnace; iron compounds; aluminum compounds (e.g. sulfate, alums); and carbon (activated or partially activated), particularly from coal ash sources.

### Precipitate Produced by the Reagents and Methods

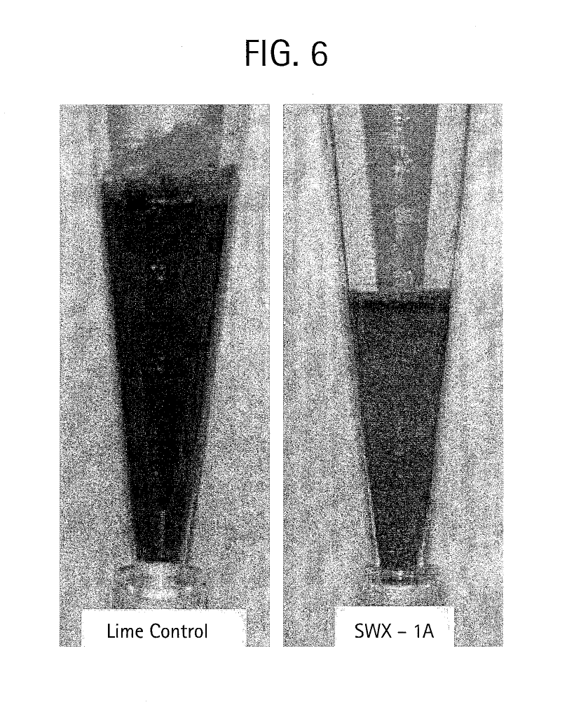

The precipitate may contain the reagent described herein and one or more heavy metals, such as, for instance, chromium, cobalt, copper, iron, cadmium, mercury, lead, nickel, antimony, arsenic, barium, gold, manganese, molybdenum, selenium, silver, tin, tungsten, vanadium, and zinc. The precipitate produced by the methods described herein is denser, and features a lower volume solid wasteform compared to a precipitate produced when lime is used without the reagents described herein (See, FIG. 6).

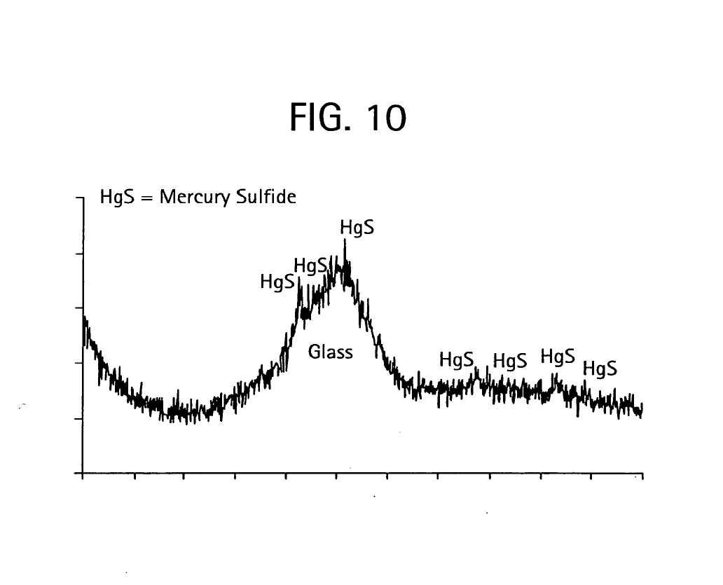

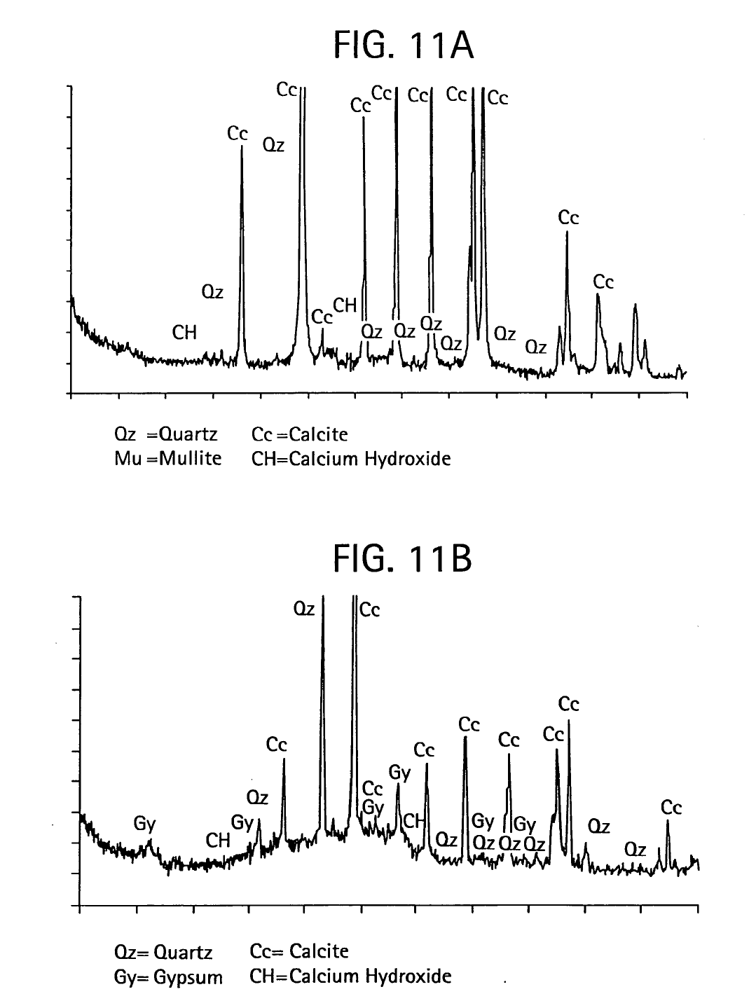

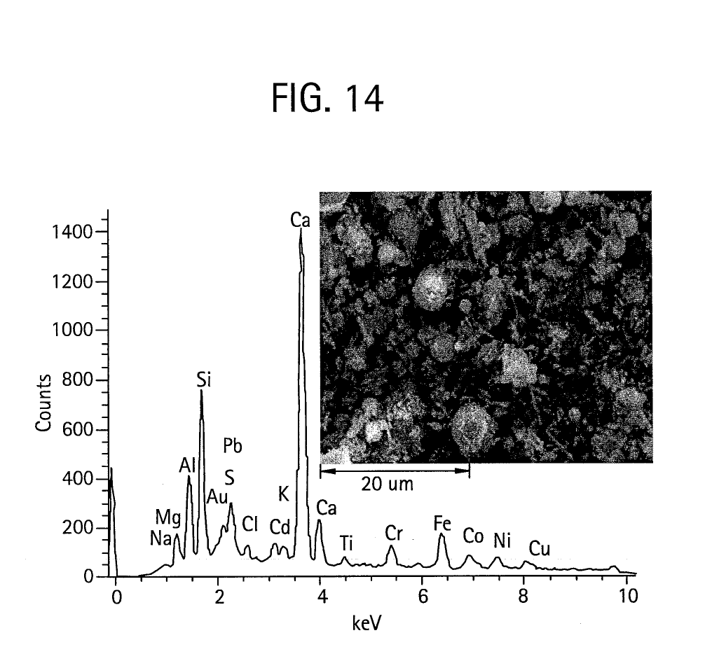

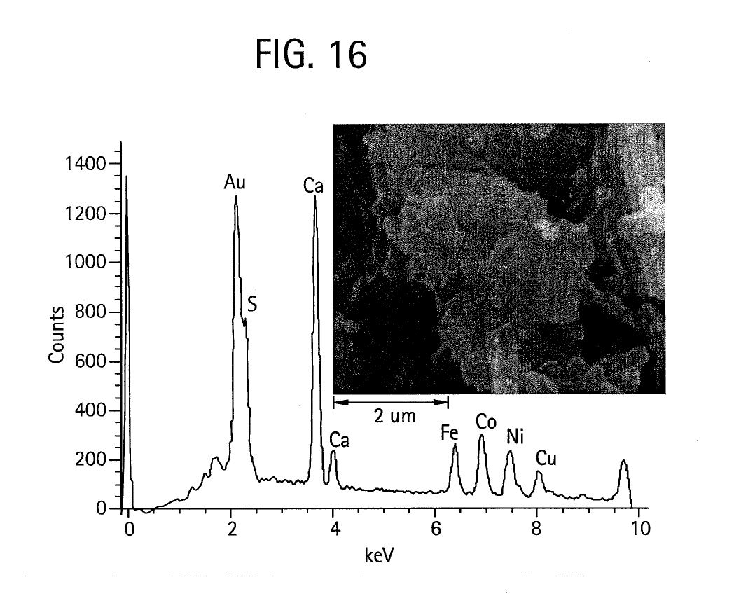

The precipitate accumulated using the reagent containing the heavy metals will have a solids bulk density typically in the range 1.5-2.5 g/cm³, with a true particle density approximating that of the metal hydroxide (3.3-4.2 g/cm³). FIGS. 10-13 show typical examples of the mineral forms precipitated using the reagent, as determined by X-ray powder diffraction analysis. FIGS. 14-16 show high magnification scanning electron micrographs of the dense microstructures of the precipitated solid wasteforms, with chemical data, provided by energy dispersive X-ray anaylsis (EDXA) analysis, confirming the presence of the target fixated metals. This analysis shows the presence of sulfoaluminate as well as silicate bonding in the wasteforms, indicative of both complexation and encapsulation of the fixated metals. This provides for a substantially more stable chemical environment for metal fixation than the simple formation of metal hydroxides by lime treatment.

The metal fixated precipitates produced with the reagents have high stability to environmental stressing, for example, as would be encountered by exposure to low pH conditions simulated by the EPA TCLP test (See, later Tables 10, 14)

The precipitate can be engineered using Stokes' law, allowing a combination of extended suspension of silicate-bearing particles for enhanced residence time and subsequent reactivity compared to in-solution lime phases, and a lower solid volume for the precipitated, fixated material.

Stokes' Law can be used to calculate particle settling velocities (V) in fluids as follows:

V=2R²(ρₛ−ρₗ)g/9u,

where

R=Particle Radius (m)

ρₛ=solid true particle density (kg/m³)=

ρₗ=liquid density (kg/m³)

g=acceleration due to gravity (9.81 m/s²)

u=liquid viscosity (kg/m*s)

For the aqueous systems considered, the liquid density and viscosity are fixed (1000 kg/m³ and 0.001 kg/m*s, respectively) such that the settling velocity can be calculated as follows:

V=2180R²(ρₛ−1000), in m/s.

This result multiplied by 3600 gives the distance a particle of the given size and density would settle in one hour.

Typical setting rates in water for a reagent with a true particle density of 2500 kg/m³ are as follows:

TABLE 3

| Particle Size (μm) | Settling Rate (m/hr) |
|---|---|
| 500 | 736 |
| 250 | 184 |
| 100 | 29.4 |
| 75 | 16.6 |
| 45 | 5.96 |
| 30 | 2.65 |
| 20 | 1.18 |
| 15 | 0.662 |
| 10 | 0.294 |
| 5 | 0.074 |
| 1 | 0.003 |

Thus, by adjusting the particle size parameter R, Stokes' Law can be applied as a means of adjusting or extending the settling time of the reagent to enhance and/or maximize metal capture efficiency. For example, the residence time in a 1 m deep reaction vessel for a 500 μm reactant particle in the above example is only 5 seconds, where for a reactant particle of 100 μm it is 2 minutes. As the particle size decreases, the residence time in the above example increases significantly, to 8 minutes for a 50 μm particle, 32 minutes for a 25 μm particle, 3½ hours at 10 μm and up to 14 hours for a 5 μm particle.

### DETAILED DESCRIPTION OF THE PREFERRED EMBODIMENTS

### Example 1

### Optimization of Neutralization Capacity of Reagents

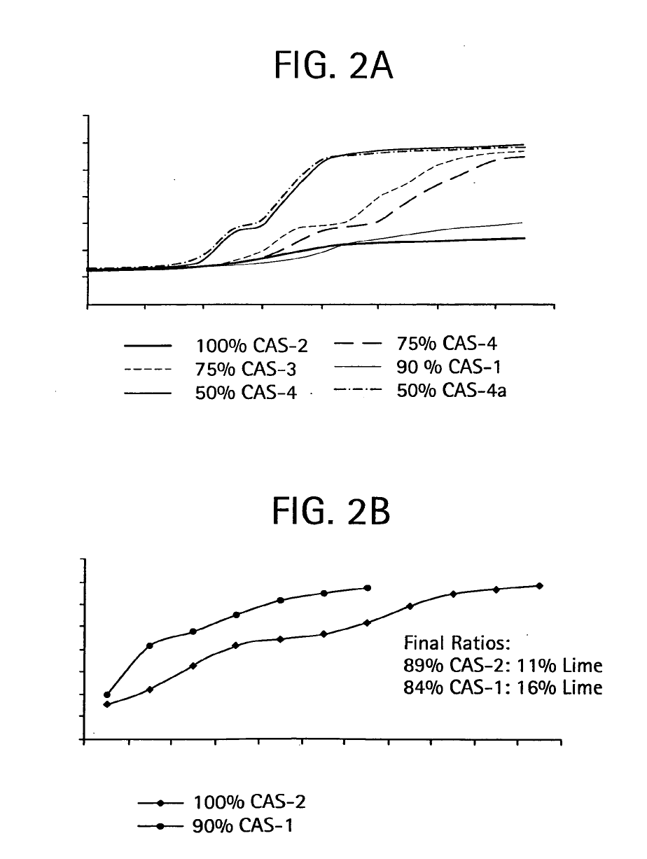

An illustration of the capacity of various reagent formulations to neutralize acidic metal solutions is shown graphically in FIG. 2. This is a summary of neutralization curves from series of experiments conducted to determine the neutralization efficiency of a variety of reagent formulations, ranging from 0-50 mass percent lime and 50-100 mass percent calcium aluminosilicate. The additions were conducted using constant agitation of the solutions over the initial 30 minutes to one hour. The dosage rates are given in grams of reagent powder added to 50 L samples of acidic metal solutions adjusted to a starting pH of approximately 2.5. These examples are typical of the type of customization that can be used to tailor the reagent formulations to a specific wasteform.

The data show that 50:50 CAS-Lime reagent formulations generally require 1.0-1.2 grams per liter to neutralize the acidic metal solutions, and 75:25 CAS-lime reagent formulations require 1.8-2.0 grams per liter.

The above examples show the ability of certain select CAS sources to provide significant acid neutralization potential with optimal minimum additions of lime.

### Example 2

### Benchscale Metals Capture in Acidic Sulfate Solutions: Comparison of Calcium Oxide and Formulations

Tables 4 and 5 show the effect of a pure lime-based reagent on the solution chemistry for surrogate acidic sulfate solutions with selected surrogate metals cobalt (Co), copper (Cu), iron (Fe), nickel (Ni), all prepared at a nominal concentration of 50 ppm for each surrogate metal.

TABLE 4
PURE CALCIUM OXIDE AT 1.5 G/L IN PH 2.4
SURROGATE METALS SOLUTION: SOLUTION DATA

| Parameters | Units | Initial | 30 min. | 5 hours | 1 day | 7 days | 28 days |
|---|---|---|---|---|---|---|---|
| Calcium | (mg/L) | 1.27 | 826 | 821 | 793 | 736 | 756 |
| Magnesium | (mg/L) | <0.02 | <0.02 | <0.02 | <0.02 | <0.02 | 0.03 |
| Potassium | (mg/L) | <0.02 | <0.02 | <0.02 | <0.02 | 0.09 | 0.23 |
| Sodium | (mg/L) | 2.1 | 2.7 | 2.8 | 2.7 | 2.6 | 2.5 |
| Aluminum | (mg/L) | 0.117 | 0.038 | 0.083 | 0.013 | 0.006 | 0.051 |
| Silicon | (mg/L) | 0.281 | 0.030 | 0.065 | 0.187 | 0.255 | 0.195 |

TABLE 5
PURE CALCIUM OXIDE AT 1.5 G/L IN PH 2.4 SURROGATE METALS
SOLUTION: COBALT, COPPER, IRON AND NICKEL CAPTURE

| Parameters | Units | Initial | 30 min. | 5 hours | 1 day | 7 days | 28 days |
|---|---|---|---|---|---|---|---|
| Cobalt | (mg/L) | 50.6 | 0.074 | 0.057 | 0.090 | 0.029 | 0.042 |
| Copper | (mg/L) | 48.2 | 0.19 | 0.382 | 0.767 | 0.093 | 0.808 |
| Iron | (mg/L) | 50.9 | 0.084 | 0.095 | 0.101 | 0.061 | 0.039 |
| Nickel | (mg/L) | 44.4 | 0.061 | 0.046 | 0.074 | 0.023 | 0.034 |

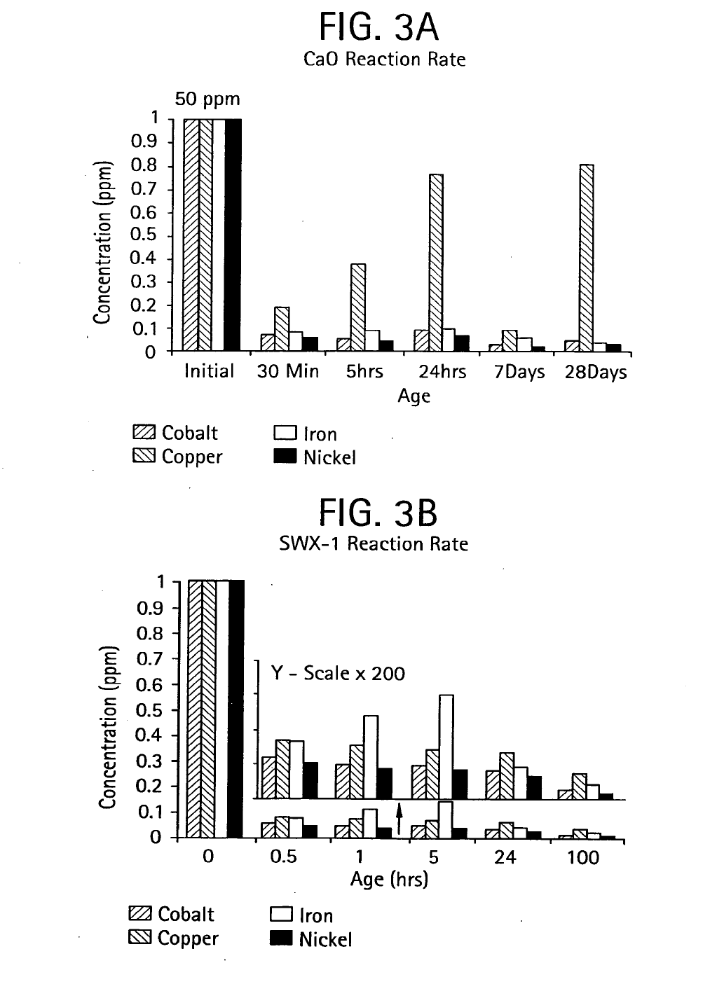

Tables 6 and 7 compare the effectiveness of typical reagents formulated at 50:50 CAS-Lime with selected calcium aluminosilicate sources. The results for both the lime formulations and the reagents are presented graphically in FIG. 3, with the upper graph providing data for lime and the lower graph for the reagent.

TABLE 6
TYPICAL FORMULATIONS AT 1.5 G/L IN PH 2.4
SURROGATE METALS SOLUTION: SOLUTION DATA

| Parameters | Units | Initial | 30 min. | 5 hours | 1 day | 7 days | 28 days |
|---|---|---|---|---|---|---|---|
| Calcium | (mg/L) | 1.27 | 424 | 424 | 411 | 418 | 410 |
| Magnesium | (mg/L) | <0.02 | <0.02 | <0.02 | <0.02 | <0.02 | <0.02 |
| Potassium | (mg/L) | <0.02 | <0.02 | <0.02 | <0.02 | <0.02 | 0.703 |
| Sodium | (mg/L) | 2.1 | 2.4 | 2.6 | 2.4 | 2.5 | 3.7 |
| Aluminum | (mg/L) | 0.117 | 0.168 | 0.380 | 0.066 | 0.063 | 0.059 |
| Silicon | (mg/L) | 0.281 | 0.079 | 0.305 | 0.249 | 0.227 | 0.560 |

TABLE 7
TYPICAL FORMULATIONS AT 1.5 G/L IN PH 2.4 SURROGATE
METALS SOLUTION: COBALT, COPPER, IRON, NICKEL CAPTURE

| Parameters | Units | Initial | 30 min. | 5 hours | 1 day | 7 days | 28 days |
|---|---|---|---|---|---|---|---|
| Cobalt | (mg/L) | 50.6 | 0.061 | 0.049 | 0.040 | 0.013 | 0.075 |
| Copper | (mg/L) | 48.2 | 0.083 | 0.072 | 0.067 | 0.037 | 0.165 |
| Iron | (mg/L) | 50.9 | 0.082 | 0.147 | 0.046 | 0.021 | 0.095 |
| Nickel | (mg/L) | 44.4 | 0.052 | 0.041 | 0.033 | 0.010 | 0.063 |

The data clearly show the effectiveness of the reagents, particularly with respect to fixation of solution copper in the test samples. The slight rise in iron out to 5 hours age in the reagent is attributable to soluble iron constituents in the CAS materials. These iron constituents subsequently react with the reagent and are re-precipitated.

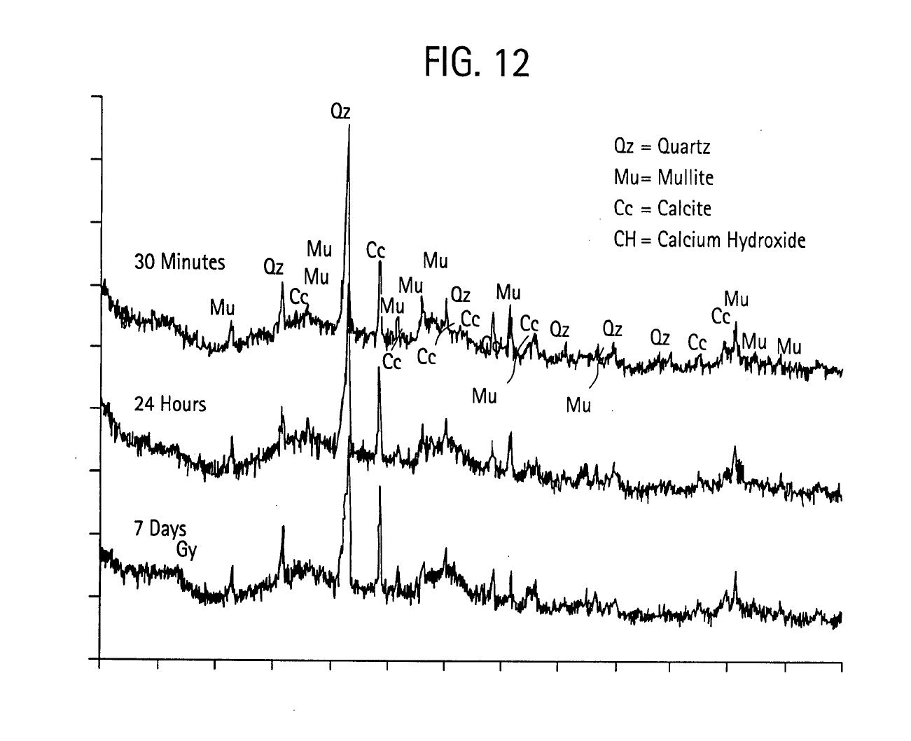

FIG. 12 shows a typical series of X-ray diffraction patterns for the precipitate as it sequesters metals from acidic sulfate solution. In addition to conventional hydroxide precipitation, the reagents tend to form alumino-ferrite trisulfate phases of the ettringite family, which are stable, insoluble forms which are capable of substituting and sequestering many metals into their structures.

### Example 3

### Pilot Scale Metals Capture in Acidic Sulfate Solution, pH 2.4: Comparison of Calcium Oxide and Formulations

Following the success of the benchscale tests, selected formulations were examined at pilot scale (50 L) to (a) confirm metals removal efficiency, and (b) evaluate the stability of the precipitated products during simulated environmental stressing tests using the TCLP protocol. In general, wasteforms will contain target metals measured in parts per million, such that the actual amount of solid per liter of solution is relatively small, thus necessitating that the treatment be conducted at a larger scale to produce sufficient sample material for subsequent analysis and stressing tests.

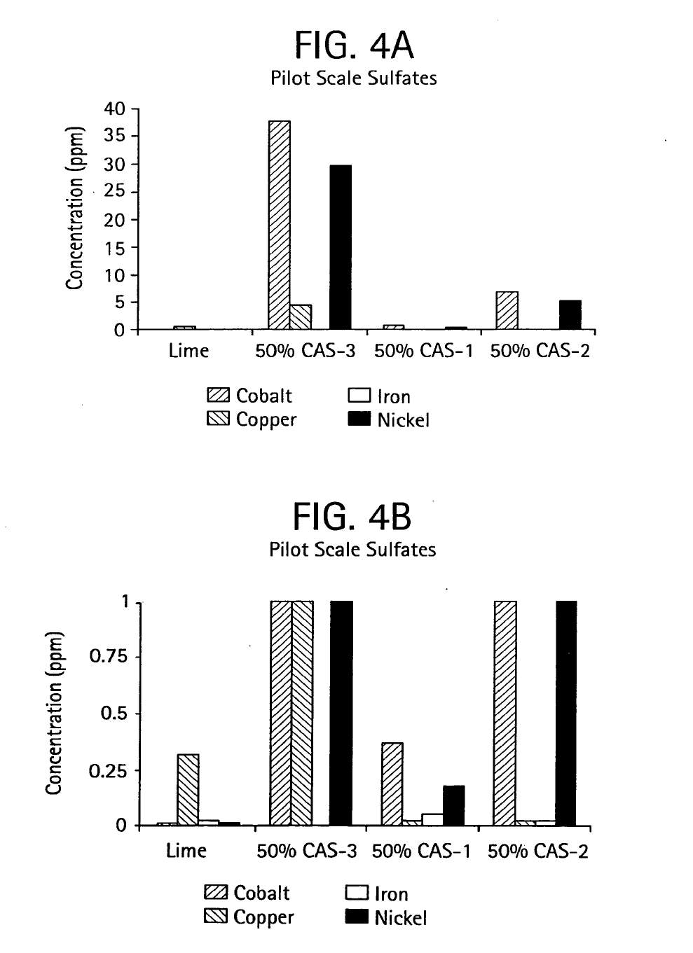

Surrogate solutions with 50 ppm each of cobalt (Co), copper (Cu), nickel (Ni) and iron (Fe), were prepared. The results are presented in Tables 8 and 9 for the solution chemistry of lime and three typical reagent formulations. The data are presented graphically in FIG. 4, which shows the effectiveness of the reagents.

TABLE 8
PILOT SCALE SULFATE SOLUTION DATA FOR
LIME AND REAGENTS: SOLUTION DATA

| Parameters | Units | Control | Lime | SWX-1 | SWX-2 | SWX-3 |
|---|---|---|---|---|---|---|
| Calcium | (mg/L) | 33.8 | 804 | 506 | 441 | 511 |
| Magnesium | (mg/L) | 8.39 | 0.02 | 13.9 | 5.56 | 8.55 |
| Potassium | (mg/L) | 1.75 | 2.15 | 2.11 | 2.21 | 2.26 |
| Sodium | (mg/L) | 17.7 | 20.2 | 20.0 | 19.7 | 22.5 |
| Aluminum | (mg/L) | 0.066 | 0.050 | 0.017 | 0.020 | 0.018 |
| Silicon | (mg/L) | 0.589 | 0.427 | 2.70 | 0.966 | 2.40 |

TABLE 9
PILOT SCALE SULFATE SOLUTION DATA FOR LIME AND
REAGENTS: COBALT, COPPER, IRON, NICKEL CAPTURE

| Parameters | Units | Control | Lime | SWX-1 | SWX-2 | SWX-3 |
|---|---|---|---|---|---|---|
| Cobalt | (mg/L) | 50.7 | 0.007 | 37.6 | 0.366 | 6.67 |
| Copper | (mg/L) | 48.7 | 0.312 | 4.26 | 0.017 | 0.018 |
| Iron | (mg/L) | 52.4 | 0.019 | 0.005 | 0.044 | 0.018 |
| Nickel | (mg/L) | 37.0 | 0.006 | 29.5 | 0.172 | 5.01 |

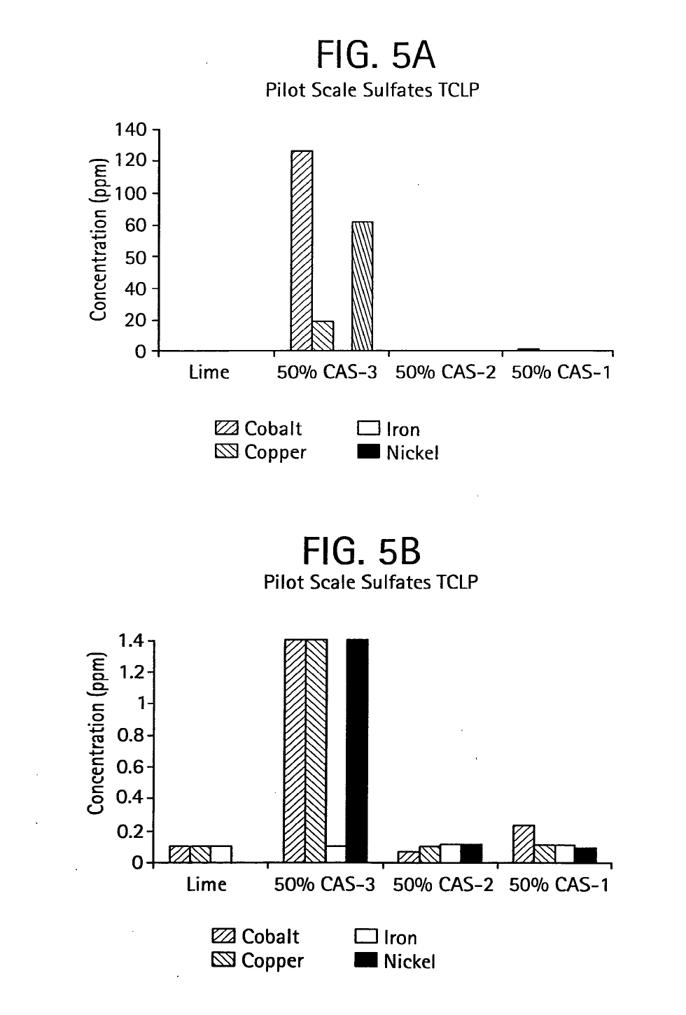

The TCLP environmental stressing data for the 28 day old precipitates is provided in Table 10, with the results shown graphically in FIG. 5.

TABLE 10
TCLP LEACHATE DATA FOR SOLID PHASE
RECOVERED FROM PILOT SCALE SOLUTION
TESTING FOR LIME AND REAGENTS:

| Leachable SO₄ Metals | Units | Lime | SWX-1 | SWX-2 | SWX-3 |
|---|---|---|---|---|---|
| Leachable Chromium | mg/L | 0.00 | 0.00 | 0.00 | 0.00 |
| Leachable Cobalt | mg/L | 0.10 | 126 | 0.23 | 0.06 |
| Leachable Copper | mg/L | 0.10 | 18.8 | 0.10 | 0.10 |
| Leachable Iron | mg/L | 0.10 | 0.10 | 0.10 | 0.10 |
| Leachable Nickel | mg/L | 0.00 | 80.9 | 0.09 | 0.10 |

It is evident that the solid wasteforms have high stability to environmental stressing (TCLP), with results for the target metals easily within specification limits for most discharge categories.

Compared with lime, the reagent chemistry produces a much denser, lower volume solid wasteform (See, FIG. 6). This can be engineered using Stokes' law, allowing a combination of extended suspension of silicate-bearing particles for enhanced residence time and subsequent reactivity compared to in-solution lime phases, and a lower solid volume for the precipitated, fixated material.

### Example 4

### Pilot Scale Metals Capture in Acid Sulfate Solution, pH 2.4: Variation of the Reagent Formulation

A further illustration of the effectiveness of the invention comes from pilot scale (50 L) evaluation of alternative reagent formulations with optimized CAS-lime ratios.

Surrogate solutions with 50 ppm each of cobalt (Co), copper (Cu), nickel (Ni) and iron (Fe), were prepared.

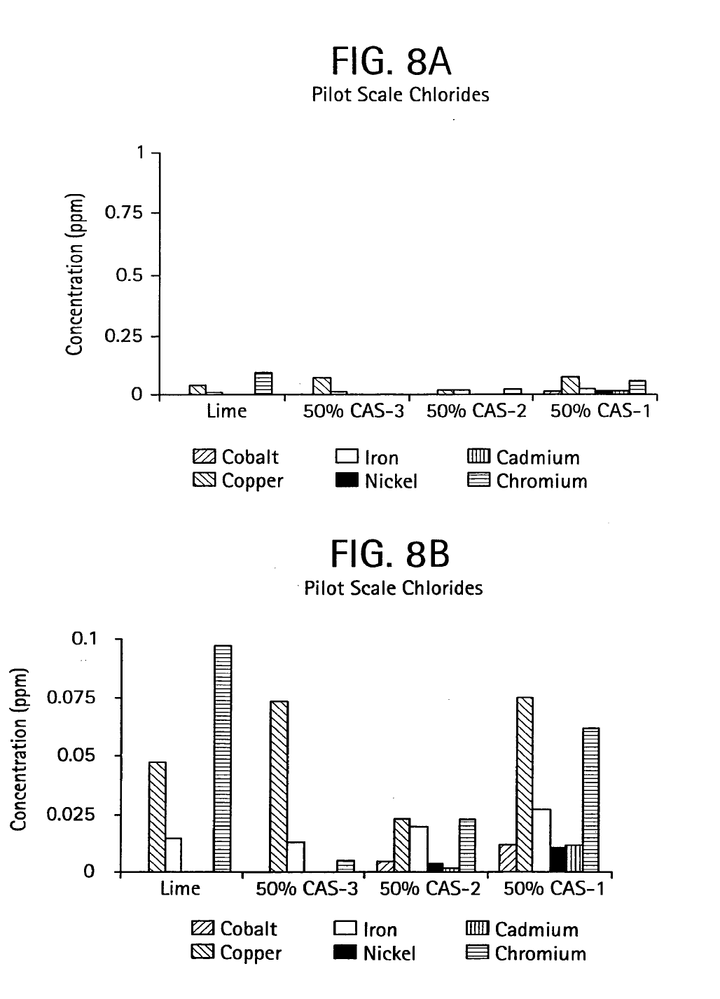

The metal fixation data are presented graphically in FIG. 8, which shows the effectiveness of the reagents.

There is a general trend to higher metals capture with increased CAS content. Up to 90% CAS can provide significant reduction in solution metals, when properly tested for the ability of the blend to increase solution pH. Similarly, the CAS-2, after augmented with 15% lime, provides good metals capture.

### Example 5

### Pilot Scale Metals Capture in Acidic Chloride Solutions, pH 2.4: Comparison of Calcium Oxide and Formulations

Following successful proof of concept with sulfates, a series of acidic metal chloride tests (25 ppm for each surrogate target metal) were performed. The solution chemistries for the metal chloride test series are presented in Tables 11-13. In addition to surrogates containing cobalt (Co), copper (Cu), iron (Fe) and nickel (Ni) (Table 12), these test series were expanded to included surrogate solutions containing cadmium (Cd), chromium (Cr) and lead (Pb) surrogates (Table 13).

TABLE 11
PILOT SCALE CHLORIDE SOLUTION DATA FOR
LIME AND REAGENTS: SOLUTION DATA

| Parameters | Units | Initial | Lime | SWX-1 | SWX-2 | SWX-3 |
|---|---|---|---|---|---|---|
| Calcium | (mg/L) | 1.61 | 1070 | 758 | 877 | 849 |
| Magnesium | (mg/L) | 0.16 | <0.01 | <0.01 | 0.03 | 0.03 |
| Potassium | (mg/L) | 0.06 | 2.44 | 2.38 | 3.73 | 2.69 |
| Sodium | (mg/L) | <0.5 | 21.5 | 20.7 | 34.1 | 23.6 |
| Aluminum | (mg/L) | 0.059 | 0.009 | 0.014 | 0.190 | 0.141 |
| Silicon | (mg/L) | 0.150 | 0.195 | 0.364 | 0.267 | 0.297 |

TABLE 12
PILOT SCALE CHLORIDE SOLUTION DATA FOR LIME AND
REAGENTS: COBALT, COPPER, IRON, NICKEL CAPTURE

| Parameters | Units | Initial | Lime | SWX-1 | SWX-2 | SWX-3 |
|---|---|---|---|---|---|---|
| Cobalt | (mg/L) | 26.2 | <0.001 | <0.001 | 0.005 | 0.013 |
| Copper | (mg/L) | 26.1 | 0.047 | 0.072 | 0.023 | 0.075 |
| Iron | (mg/L) | 25.7 | 0.015 | 0.013 | 0.020 | 0.027 |
| Nickel | (mg/L) | 25.8 | <0.001 | <0.001 | 0.004 | 0.011 |

TABLE 13
PILOT SCALE CHLORIDE SOLUTION DATA FOR LIME AND
REAGENTS: CHROMIUM, CADMIUM, LEAD CAPTURE.

| Parameters | Units | Initial | Lime | SWX-1 | SWX-2 | SWX-3 |
|---|---|---|---|---|---|---|
| Chromium | (mg/L) | 26.1 | 0.097 | 0.005 | 0.023 | 0.061 |
| Cadmium | (mg/L) | 26.1 | 0.047 | 0.072 | 0.023 | 0.075 |
| Lead* | (mg/L) | 26.2 | 13.5 | 10.3 | 2.02 | 3.17 |

*Note increased lead capture with SWX formulations

The metal capture data for these test series are presented graphically in FIG. 8.

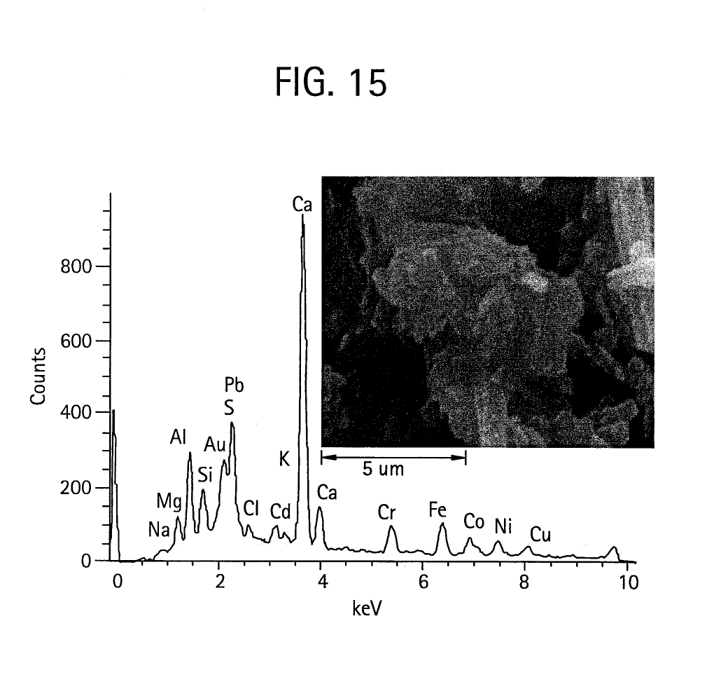

Typical examples of the microstructures of the stable precipitate from reagent treatment of the acidic chloride surrogate solutions are shown in FIG. 14, which can be contrasted with the high surface area precipitate from a pure lime system in FIG. 15.

The TCLP data for the acidic chloride metal solutions shows a marked increase in retention efficiency with the reagent, most dramatically for retention of copper and lead, as is shown in Table 14.

TABLE 14
TCLP LEACHATE DATA FOR SOLID PHASE RECOVERED
FROM PILOT SCALE CHLORIDE SOLUTION DATA
FOR LIME AND REAGENTS:

| Metals | Units | Lime | SWX-1 | SWX-2 | SWX-3 |
|---|---|---|---|---|---|
| Leachable Cobalt | mg/L | 0.10 | 0.10 | 0.10 | 0.10 |
| Leachable Copper | mg/L | 2.40 | 0.50 | 0.10 | 0.10 |
| Leachable Iron | mg/L | 0.10 | 0.10 | 0.10 | 0.10 |
| Leachable Chromium | mg/L | 1.40 | 2.00 | 0.30 | 0.10 |
| Leachable Cadmium | mg/L | 0.10 | 0.10 | 0.10 | 0.10 |
| Leachable Lead* | mg/L | 19.70 | 8.50 | 0.80 | 0.10 |

*Note increased lead retention with SWX formulations

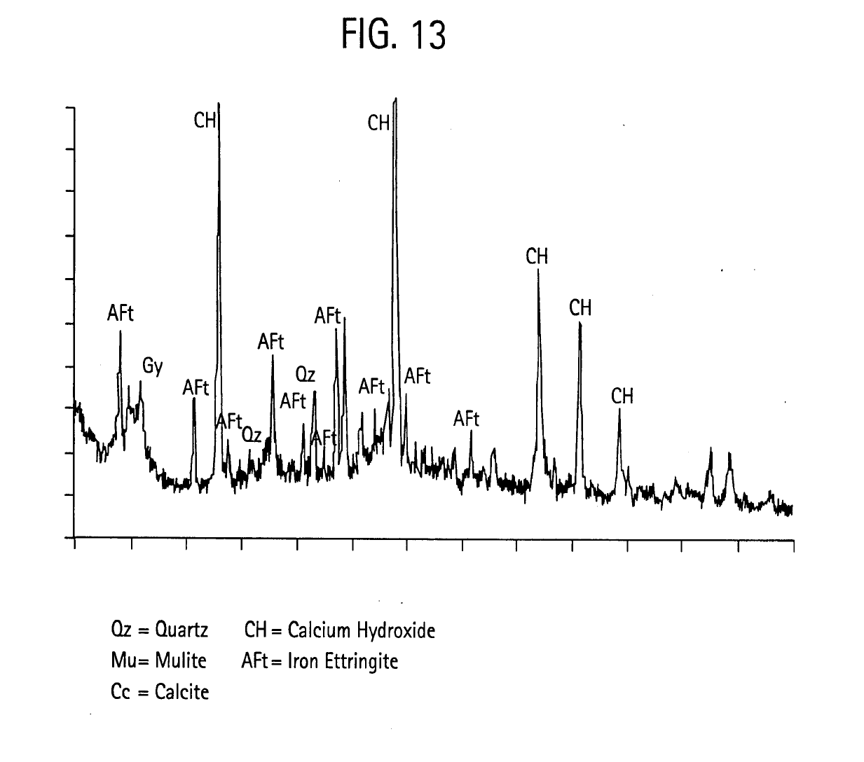

Superior retention of metals such as lead, chromium and copper is produced in acidic chloride wastewaters by the reagents. As shown in FIG. 13, the reagent can be selected to provide beneficial sulfate to the reaction to produce insoluble calcium sulfoaluminate (ettringite) phases, which greatly enhances the ability of the precipitate to resist release of target metals during TCLP stressing tests.

### Example 6

### Capture of Lead, Cadmium and Mercury

A surrogate solution containing 25 ppm mercury in the form of mercury nitrate, Hg(NO₃)₂, was treated with a composition containing a sulfide enhanced CAS reagent. The CAS reagent in this series of tests contained approximately 1% sulfide sulfur by mass. One liter of solution was treated with 1.5 g of reagent, with continuous agitation for the initial 30 minutes of exposure. From an initial concentration of 25 ppm, the treated solution had a mercury level after 7 days of 0.299 ppm. This represents a reduction in solution mercury of 83 times.

FIG. 10 shows the mineralogy by X-ray diffraction of the solid phase recovered from the treated mercury solution. The X-ray powder diffraction pattern confirms the presence mercury sulfide in the solid phase, at the expected low concentration. The stoichiometry of the reaction components, assuming compete recovery of the solid formulation, would be less that 2% mercury sulfide by mass.

What is claimed:

1. A method for removing a contaminant from an impure material comprising providing a reagent comprising a calcium aluminosilicate (CAS) source and lime.

2. The method according to claim 1, wherein the contaminant is selected from chromium, cobalt, copper, iron, mercury, cadmium, lead, nickel, antimony, arsenic, barium, gold, manganese, molybdenum, selenium, silver, tin, tungsten, vanadium, or zinc.

3. The method according to claim 1, wherein at least 90% of heavy metal ions present in the impure material are removed.

4. The method according to claim 1, wherein at least about 1.0 gram of the reagent is added per liter of the impure material.

5. A method for removing contaminants from impure materials comprising
(a) hydrolyzing lime components in a reagent comprising a calcium aluminosilicate (CAS) source and lime;
(b) neutralizing acidity in a solution containing the reagent;
(c) hydrolyzing an aluminosilicate network in the reagent at elevated pH thereby producing silicates and aluminates in solution;
(d) reacting the solubilized aluminates in the presence of lime and sulfate thereby producing calcium sulfoaluminates, related to ettringite, which often have iron substituting for aluminum in the structure;
(e) forming a complex alkali silicate and aluminosilicate polymeric species in solution (where, N=Na or K); and
(f) reacting the complex alkali silicate and aluminosilicate polymeric species with lime in solution to produce calcium silicate hydrate (C—S—H).

6. The method according to claim 5 further comprising
(g) precipitating insoluble metal hydroxides; and
(h) complexing the metals in insoluble calcium sulfoaluminates and calcium silicate hydrates formed by the sulfo-pozzolanic and silico-pozzolanic reactions of steps (a) through (f).

7. The method according to claim 5, wherein the calcium aluminosilicate (CAS) source comprises at least one of calcium oxide, aluminum oxide, silicon oxide, iron oxide, magnesium oxide, sodium oxide, potassium oxide, or sulfate.

8. The method according to claim 5, wherein the calcium aluminosilicate (CAS) source comprises at least one of calcium oxide present in about 20 to 50 wt. %, aluminum oxide present in about 5 to 35 wt. %, silicon oxide present in about 20 to 70 wt. %, iron oxide present in about 0 to 15 wt. %, magnesium oxide present in about 0 to 12 wt. %, sodium oxide present in about 0 to 5 wt. %, potassium oxide present in about 0 to 3 wt. %, or sulfate present in about 0 to 5 wt. %.

9. The method according to claim 5, wherein the lime is present in an amount of about 5-75 wt. %.

10. The method according to claim 5, wherein the calcium aluminosilicate source is one or more selected from the group consisting of coal combustion by-products.

11. The method according to claim 5, wherein the calcium aluminosilicate source is at least one of fly ash from pulverized coal combustion, bottom ash from pulverized coal combustion, spray drier ash, fluidized bed combustion ash, iron production slags, non-ferrous slags, post-industrial glasses, or post-consumer glasses.

12. The method according to claim 5, wherein the reagent further comprises at least one of sulfates; by-product gypsum from flue gas desulfurization or neutralization of acidic water; sulfides; iron compounds; aluminum compounds; or carbon.

13. The method according to claim 5, wherein the reagent is effective in removing 90 or more percent of all heavy metal ions present in an impure aqueous material.

14. The method according to claim 5, wherein the reagent is in the form of a particle and a majority of particles are less than about 500 μm in diameter.

15. The method according to claim 5, wherein the lime is obtained from the group of consisting of lime kiln dust, by-product lime from acetylene manufacture and residues from fluid bed reactors and combustors.

16. The method according to claim 5, wherein the reagent is in particle form and the mean particle sizes of the reagent are selected using the relationship V=2180R²(ρₛ−1000) in m/s.

17. The method according to claim 12, wherein the sulfate is calcium sulfate or gypsum; the by-product gypsum is chemical gypsum; the sulfide is ground granulated slag from an iron ore blast furnace; the aluminum compound is aluminum sulfate or alums; or the carbon is activated or partially activated carbon.

18. The method according to claim 13, wherein the impure aqueous material is wastewater.

19. A precipitate produced by the method of claim 5.
